(19) United States
(12) Patent Application Publication
(10) Pub. No.: US 2016/0283250 A1
(43) Pub. Date: Sep. 29, 2016

(54) BOOT CONTROLLING PROCESSING APPARATUS

(71) Applicant: FUJITSU LIMITED, Kawasaki-shi (JP)

(72) Inventor: Tomonori FUJIWARA, Yamato (JP)

(73) Assignee: FUJITSU LIMITED, Kawasaki-shi (JP)

(21) Appl. No.: 15/054,242

(22) Filed: Feb. 26, 2016

(30) Foreign Application Priority Data
Mar. 24, 2015 (JP) 2015-060754

(51) Int. Cl. G06F 9/44

(52) U.S. Cl. CPC G06F 9/4401

(57) ABSTRACT

An information processing apparatus includes a plurality of arithmetic processing units, a main memory, and an input/output unit. At least any one of the plurality of arithmetic processing units executes an initial process containing at least one of an initialization process and a diagnosis process for a first area, used for loading OS from the input/output unit, of the main memory. A first arithmetic processing unit, upon completing the initial process for the first area, loads the OS into the first area from the input/output unit. A second arithmetic processing unit starts the initial process for a remaining area, not yet subjected to the initial process, of the main memory during the processing by the first arithmetic processing unit. The first arithmetic processing unit, upon completion of loading, starts booting the OS.

### CROSS-REFERENCE TO RELATED APPLICATION

This application is based upon and claims the benefit of priority of the prior Japanese Patent Application No. 2015-060754, filed on Mar. 24, 2015, the entire contents of which are incorporated herein by reference.

### FIELD

The embodiments discussed herein are related to a boot controlling apparatus.

### BACKGROUND

Processes when booting a computer system include, e.g., a process of loading an image of Operating System (OS) from an external storage medium and other equivalent mediums via an Input/Output (I/O) unit after performing a initialization/diagnosis process (which is generally called Power On Self Test (POST)) of hardware, and an OS boot process thereafter. Herein, the external storage medium and other equivalent mediums are exemplified by a disk and a storage device on a network.

The initialization/diagnosis process entails executing processes targeting on a Central Processing Unit (CPU), a memory, the I/O unit and other equivalent components. By the way, over the recent years, the computer has been taking initialization/diagnosis time as a memory capacity has increased. A process of loading an OS image and an OS boot process take a long period of time for waiting the boot, depending on I/O performance or a throughput when booting the OS as the case may be.
[Patent document 1] International Publication Pamphlet No. WO 2010/058440
[Patent document 2] Japanese Laid-Open Patent Publication No. 2010-146142
[Patent document 3] International Publication Pamphlet No. WO 2008/001671
[Patent document 4] Japanese Laid-Open Patent Publication No. 2007-94528

### SUMMARY

According to an aspect of the embodiments, an information processing apparatus includes a plurality of arithmetic processing units, a main memory to be accessible respectively from the plurality of arithmetic processing units, and an input/output unit to be accessible respectively from the plurality of arithmetic processing units. In the information processing apparatus, at least any one of the plurality of arithmetic processing units executes an initial process containing at least one of an initialization process and a diagnosis process for a first area, used for loading Operating System from the input/output unit, of the main memory. A first arithmetic processing unit of the plurality of arithmetic processing units, upon completing the initial process for the first area, loads the Operating System into the first area from the input/output unit. A second arithmetic processing unit of the plurality of arithmetic processing units starts the initial process for a remaining area, not yet subjected to the initial process, of the main memory during the processing by the first arithmetic processing unit. The first arithmetic processing unit, upon completion of loading, starts booting the Operating System.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrating a configuration of an information processing apparatus according to one embodiment;

FIG. 2 is a diagram illustrating processes when booting the information processing apparatus according to one embodiment;

FIG. 3 is a diagram illustrating boot time of an information processing apparatus according to a comparative example and the boot time of the present information processing apparatus by comparing these periods of boot time;

FIG. 4 is a diagram illustrating calculation examples of estimating the boot time in the information processing apparatus according to the comparative example and the present information processing apparatus;

FIG. 5 is a flowchart illustrating processes when booting the information processing apparatus according to one embodiment;

FIG. 6 is a flowchart illustrating processes of firmware of the information processing apparatus according to Embodiment 1;

FIG. 7 is a flowchart illustrating details of an OS boot process in Embodiment 1;

FIG. 8 is a flowchart illustrating processes of the firmware in Embodiment 2;

FIG. 9 is a flowchart illustrating details of the OS boot process in Embodiment 2;

FIG. 10 is a diagram illustrating a boot procedure when booting the information processing apparatus in Embodiment 3;

FIG. 11 is a flowchart illustrating processes of the information processing apparatus according to Embodiment 3;

FIG. 12 is a diagram illustrating a boot procedure when booting the information processing apparatus in Embodiment 4; and

FIG. 13 is a flowchart illustrating processes of the information processing apparatus according to Embodiment 4.

### DESCRIPTION OF EMBODIMENTS

According to the conventional technologies, when booting the computer, the OS boot process is started after initializing and diagnosing hardware. Herein, the OS boot process includes the process of loading the OS image and the OS boot process. The initialization/diagnosis of the hardware includes diagnosing all the memory area. It does not necessarily, however, mean that the OS boot process involves using all the memory area but using part of the memory area in many cases. A first reason why the initialization/diagnosis of the hardware and the OS boot process are carried out separately as described above is that implementation in separation facilitates the processing. Conversely, it is presumed that implementation of not separating the initialization/diagnosis of the hardware and the OS boot process has a difficulty of grasping the memory capacity for the OS boot process. A second reason lies in not yet hitherto attaining a positive improvement about reducing boot time in terms of inevitably taking some period of waiting time for diagnosing the memory.

By the way, the OS image is loaded into the memory from the external storage medium and other equivalent mediums via the I/O unit as described above. Normally, I/O performance for loading the OS image is lower than access performance to the memory in a general case. The OS boot process also occupies the boot waiting time at a fixed rate. It does not, however, mean that the OS boot process sufficiently makes use of the access performance to the memory, i.e., a memory bandwidth. Accordingly, the conventional technologies do not sufficiently make use of the higher memory access performance than the I/O performance.

An information processing apparatus according to one embodiment will hereinafter be described with reference to the drawings. A configuration of the following embodiment is an exemplification, and the present information processing apparatus is not limited to the configuration of the embodiment.

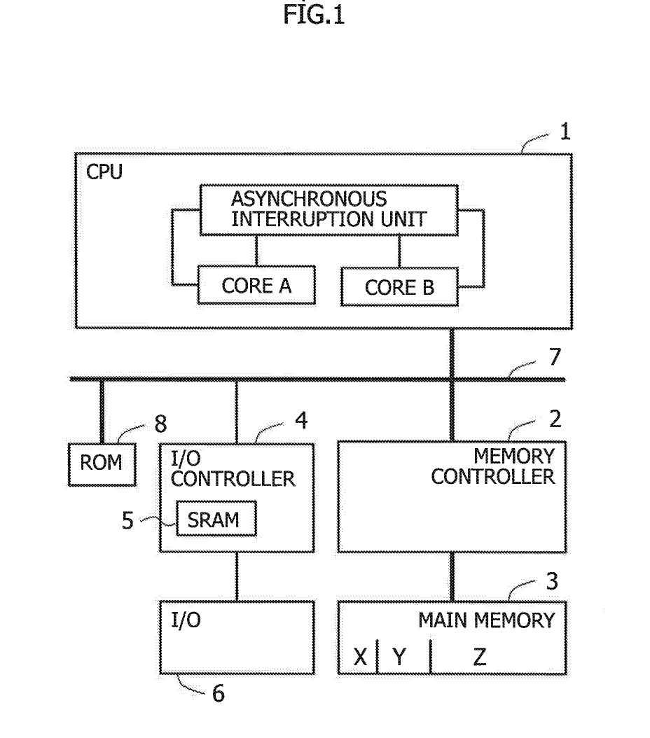

FIG. 1 illustrates a configuration of the present information processing apparatus. The information processing apparatus in FIG. 1 includes a CPU 1, a memory controller 2 connected via an internal bus 7 to the CPU 1, an I/O controller 4 connected via the internal bus 7 to the CPU 1, a memory 3 accessed by the memory controller 2, an input/output device 6 (which will hereinafter be abbreviated to an I/O 6) accessed by the I/O controller 4, and a Read Only Memory 8 (which will hereinafter be abbreviated to ROM 8).

The CPU 1 includes a core A and a core B. It does not, however, mean that a number of cores of the CPU 1 is limited to “2”. The core A and the core B issue requests to the memory controller 2 and the I/O controller 4 while executing an arbitration process with the internal bus 7, and acquire request results. An asynchronous interruption unit is provided between the core A, the core B or other equivalent cores. The core A, the core B or other equivalent cores are mutually communicable via the asynchronous interruption unit. The asynchronous interruption unit is one example of an “interface unit”. The core A and the core B are one example of a “plurality of arithmetic processing units”. The memory 3 is one example of a main memory. The I/O controller 4 and the I/O 6 are one example of an “input/output unit”.

The memory controller 2 accesses the memory 3 in response to the requests issued from the core A, the core B or a request given from the I/O controller 4. In an example of FIG. 1, a storage area of the memory 3 is segmented into areas X, Y and Z. Note that the memory 3 is also called a main storage device.

The I/O controller 4, in response to the requests from the core A, the core B or other equivalent cores, accesses the I/O 6, and executes data input/output process. The I/O 6 is, e.g., an interface with peripheral devices. Though omitted in FIG. 1, for instance, a hard disk drive, a Solid State Drive (SSD), a Network Interface Card (NIC), and other equivalent devices are connected to the I/O 6.

FIG. 1 illustrates that a Static Random Access Memory (SRAM) 5 is provided within the I/O controller 4. In the embodiment, the main storage device 3, the SRAM 5 and the I/O 6 are allocated to addresses on a physical address space of the internal bus 7. Accordingly, the core A and the core B can access the memory 3 via the memory controller 2 by accessing the addresses on the physical address space of the internal bus 7. The core A and the core B can also access the peripheral devices connected to the I/O 6 or the SRAM 5 via the I/O controller 4 by accessing the addresses on the physical address space of the internal bus 7. Note that the SRAM 5 maybe connected to the internal bus 7 outside the I/O controller 4. The SRAM 5 stores firmware, system parameters of OS, and other equivalent software components.

The I/O controller 4, in response to the requests issued from the core A, the core B or other equivalent cores, acquires data from the I/O 6 and hands over the data to the memory controller 2. In response to the requests issued from the core A, the core B or other equivalent cores, the I/O controller 4 transfers, to the I/O 6, the data handed over to the memory controller 2.

The ROM 8 stores the firmware instanced by Basic Input/Output System (BIOS) and other equivalent programs. The firmware is booted by the core A or the core B upon power-on of the information processing apparatus or resetting the information processing apparatus by a reset switch, and controls initialization/diagnosis of hardware, loading of an OS image, a startup and other equivalent operations. For example, when a plurality of cores instanced by the core A, the core B or other equivalent cores is booted upon the power-on or the resetting by the reset switch, a Boot Strap Processor (BSP) and an Application Processor (AP) are selected. The BSP manages whole firmware processes including the initialization/diagnosis, and executes the firmware processes by sharing the processes with the AP as another core.

However, one core (e.g., the core B) executes the initialization/diagnosis, and may boot the core A with a core-to-core asynchronous interruption after completing the initialization/diagnosis. Further, both of the core A and the core B are booted by the firmware, and one core (e.g., the core B) may perform the initialization/diagnosis. The other core (e.g., the core A) monitors shared resources, and may be kept in a standby status till completing the initialization/diagnosis of the area X.

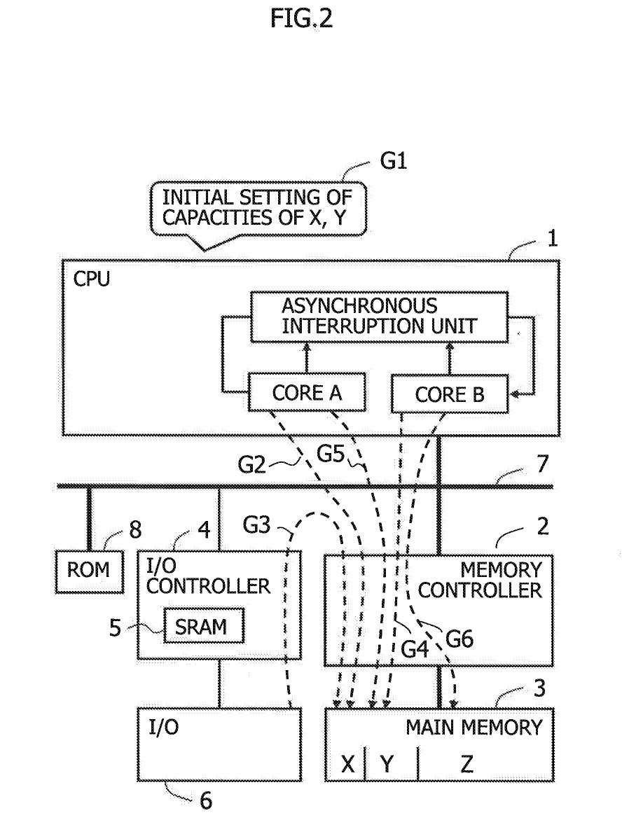

FIG. 2 illustrates a process when booting the information processing apparatus. In the information processing apparatus, before booting, capacities of the areas X, Y of the memory 3 are initially set via, e.g., the BIOS and other equivalent programs (G1). As a result, the remaining area Z other than the areas X, Y is also initially set. Capacities of the areas X, Y and other equivalent areas of the memory 3 are retained as the OS parameters by the SRAM 5 and other equivalent memories.

Herein, the area X is an area for loading the OS image. The area X is one example of a “first area”. The OS image, which is also called an execution format, is binary data to be processed by the core A, the core B or other equivalent cores. The OS image may also, however, be compressed data of a self-extracting type.

The area Y is an area for an OS boot process. The area Y stores the system parameters of the OS, management information and other equivalent information of the information processing apparatus. The OS image is the compressed data of the self-extracting type, in which case the area Y contains an area for deploying the OS execution format. The area Y is one example of a “second area”. Note that the firmware, the boot program and other equivalent programs start booting the OS upon completing the initialization/diagnosis of, e.g., the area Y. However, when completing the initialization/diagnosis of part of the area Y and part of the OS becomes bootable, the OS may starts being booted. In the embodiment, the firmware and an OS process have an interface enabling mutual notifications within the shared resource area, e.g., within the SRAM 5. However, the interface enabling the notifications between the firmware and the OS process may involve using the asynchronous interruption unit and other equivalent units between the core A and the core B in place of the SRAM 5.

The area Z is the area other than the area X and the area Y. The firmware or the OS are recognizable of a capacity and allocated address information of the area Z as the remaining areas from the parameters indicating the capacities of the areas X, Y and the allocated address information.

When the information processing apparatus is started up, at least anyone of the cores of the CPU 1 boots the firmware instanced by the BIOS and other equivalent programs. Any one of the cores of the CPU 1 or the plurality of cores operating in cooperation performs the initialization/diagnosis of the hardware by use of the firmware, and initializes the area X of the memory 3 (arrow line G2). For example, the core A runs the firmware, and initializes and diagnoses the area X for loading the OS image. It may be sufficient that the core A initializes and diagnoses the area X by using a memory bandwidth for accessing the memory 3 substantially at the maximum. The core A and the core B may, however, cooperate to initialize and diagnose the area X under management of the core A.

Next, one core (e.g., the core A) of the CPU 1 executes loading the OS image, while the other core (e.g., the core B) initializes and diagnoses the area Y subsequent to the area X of the memory 3. The core A and the core B execute loading the OS image, and initializing and diagnosing the area Y in parallel. Loading of the OS image is executed by making use of transfer performance of the I/O 6 substantially at the maximum. On the other hand, with the transfer of the OS image to the memory 3 from the I/O 6, memory access performance for initializing and diagnosing the area Y decreases from a maximum value of the memory bandwidth.

For example, the core A, after initializing and diagnosing the area Y, starts loading the OS image (arrow line G3). On the other hand, the core B, after the core A has initialized and diagnosed the area X, starts initializing and diagnosing the areas Y and Z of the memory 3 (arrow line G4). The core A completes loading the OS image. Accordingly, the core A executes loading the OS image and the core B executes initializing and diagnosing the areas Y and Z in parallel.

Next, the core A completes loading the OS image and, upon recognizing the completion of initializing and diagnosing the area Y from the interface with the core B provided in the SRAM 5 as the shared resource, starts a boot process of the OS (G5). The SRAM 5 as the shared resource is one example of an “interface unit”. On the other hand, the core B, after completing the initialization/diagnosis of the area Y, further continues initializing and diagnosing the area Z (arrow line G6). Accordingly, the core A executes the boot process of the OS and the core B initializes and diagnoses the area Z in parallel. The core B completes initializing and diagnosing the area Z.

Thereafter, the core (e.g., the core A) with the OS being booted executes the OS settings about the area Z of the memory 3. For example, the core A sets OS control data of a page table and other equivalent tables for managing the areas added along with the completion of initializing and diagnosing the area Z. With the setting of the page table and other equivalent tables, a storage management of the OS is conducted, e.g., address mapping is carried out between a virtual address space and a physical address space.

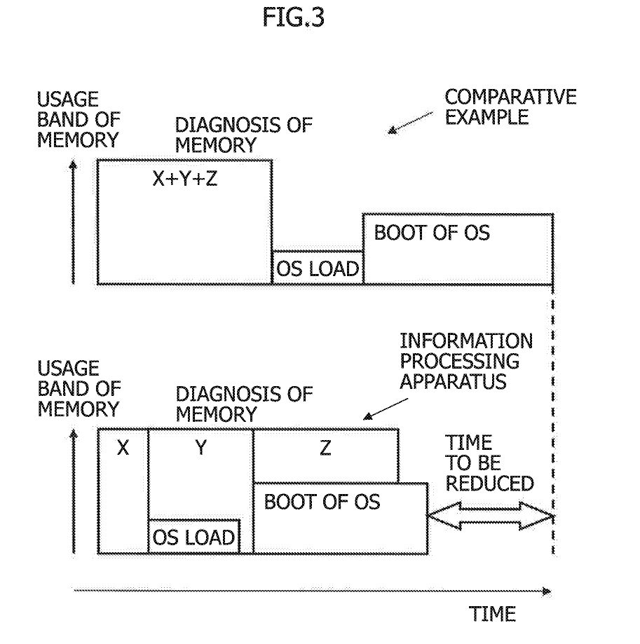

FIG. 3 illustrates boot time of an information processing apparatus according to a comparative example and the boot time of the present information processing apparatus by comparing these periods of boot time. FIG. 3 depicts a boot process of the information processing apparatus according to the comparative example at an upper stage. FIG. 3 also depicts the boot process of the present information processing apparatus at a lower stage. At both of the upper and lower stages, the axis of abscissa indicates a time base, while the axis of ordinate indicates a usage band when accessing the memory 3 in each process.

The information processing apparatus according to the comparative example executes initializing and diagnosing the area all the areas (X, Y, Z) of the memory 3, further executes loading the OS image, and boots the OS. In the processes of the comparative example, the initialization/diagnosis of the memory 3 can be implemented by using a band close to the maximum usage band with respect to the memory 3. An access speed in the I/O 6 is, however, a bottleneck to loading the OS image and booting the OS, and it follows that the access speed to the memory 3 decreases to a great degree from a maximum value of a usable band (which is also called a memory bandwidth or a memory band).

On the other hand, the present information processing apparatus executes, at first, initializing and diagnosing the area X for loading the OS image. Subsequently, the information processing apparatus executes loading the OS image and initializing and diagnosing the area Y for booting the OS in parallel. The parallel execution of loading the OS image and the initializing and diagnosing the area Y for booting the OS leads to a decrease in access speed to the memory controller 2 when initializing and diagnosing the area Y along with loading the OS image. However, as in the case of the comparative example of the execution of only loading the OS image, the access speed to the memory 3 can be restrained from decreasing due to a point that the performance of the I/O 6 becomes the bottleneck. The information processing apparatus further executes booting the OS and initializing and diagnosing the remaining area Z of the memory 3 in parallel. When booting the OS and initializing and diagnosing the remaining area Z of the memory 3 in parallel, the access speed to the memory 3 decreases in initializing and diagnosing the remaining area Z. Access efficiency of the whole boot process can be, however, restrained from decreasing. As a result of the parallel process described above, time corresponding to a period indicated by arrows in FIG. 3 is reduced, resulting in speeding up the boot of the information processing apparatus.

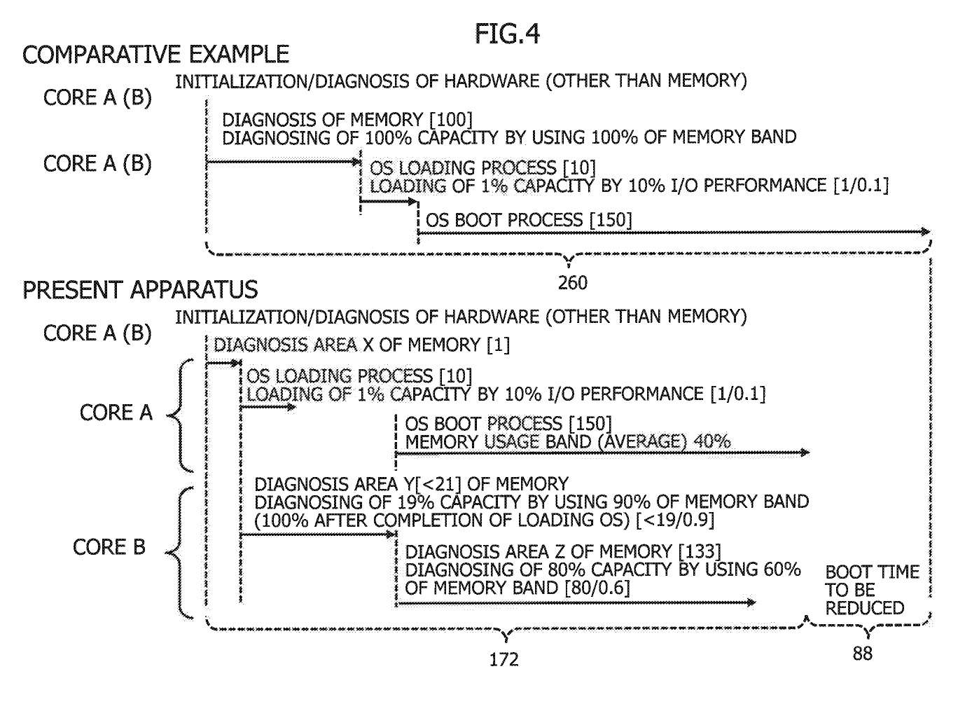

FIG. 4 illustrates calculation examples of estimating the boot time in the information processing apparatus according to the comparative example and the present information processing apparatus. It is assumed in FIG. 4 that the area X occupies 1% of the entire area, the area Y is 19%, and the area Z is 80%. It is also assumed that the performance (bandwidth) of the I/O 6 is 10% of the usable band (memory bandwidth) when accessing the memory. It is further assumed that the memory usage band when booting the OS is 40% of the memory bandwidth. It is still further assumed that the access speed (memory bandwidth) to the memory is “1” (non-dimensional). It is yet further assumed that the OS boot time is “150”. Note that the “initialization/diagnosis” of the memory is simply referred to as a “diagnosis” of the memory in FIG. 4.

In the case of the comparative example, the initialization/diagnosis time of the memory 3 becomes 100/1=100 (non-dimensional) because of initializing and diagnosing a 100% capacity of the memory area by using 100% of the memory band. Load time of the OS image becomes 1/0.1=10 because of loading a 1% capacity of the OS image by 10% I/O performance of the memory band. Note that the OS boot time is assumed to be “150”. Consequently, in the comparative example, a total of the initialization/diagnosis time of the memory 3, the load time of the OS image and the OS boot time is given by 100+10+150=260.

On the other hand, in the present information processing apparatus, the initialization/diagnosis time of the area X is given by 1/1=1 because of initializing and diagnosing the 1% area by using 100% of the memory band. Herein, any one of the core A and the core B may initialize and diagnose the area X.

With respect to load time “10” of the OS image, the initialization/diagnosis time of the area Y is given by 19/0.9=21 because of initializing and diagnosing a 19% capacity of the area Y by making use of 90% of the memory band. Accordingly, with respect to loading the OS image and initializing and diagnosing the area Y in parallel, the initialization/diagnosis time of the area Y is longer than the former. In FIG. 4, the core A loads the OS image, while the core B initializes and diagnoses the area Y. However, the core A may initialize and diagnose the area Y, while the core B may load the OS image.

The initialization/diagnosis time of the remaining area Z is given by 80/0.6=133 (<150) because of initializing and diagnosing an 80% capacity of the remaining area Z by making use of 60% of the memory band. Accordingly, in the present information processing apparatus, a period of time till completing the OS boot since starting the initialization/diagnosis of the memory is given by 1+21+150=172, which is reduced by time “88” against the comparative example.

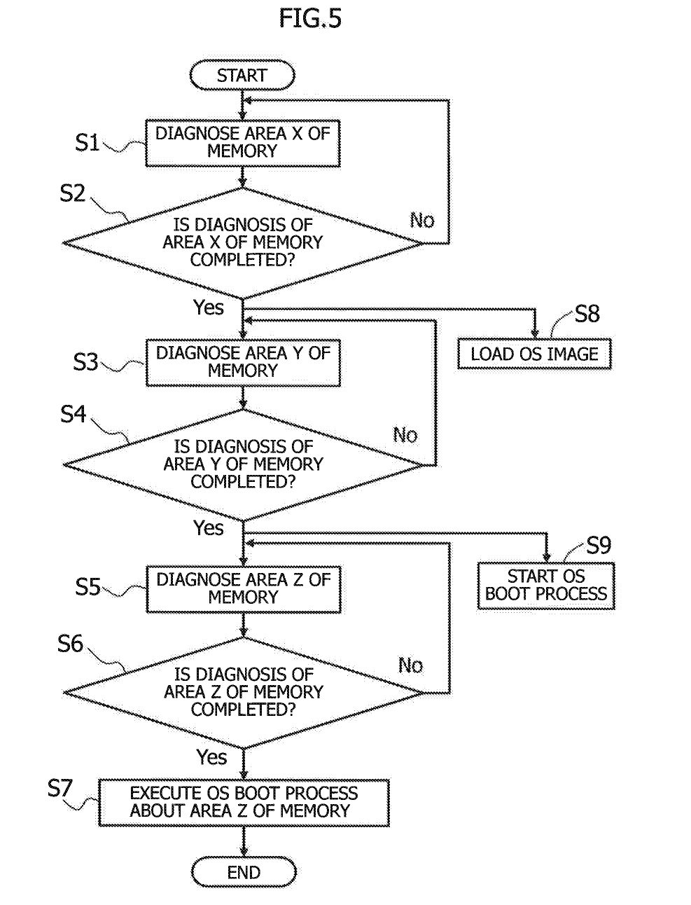

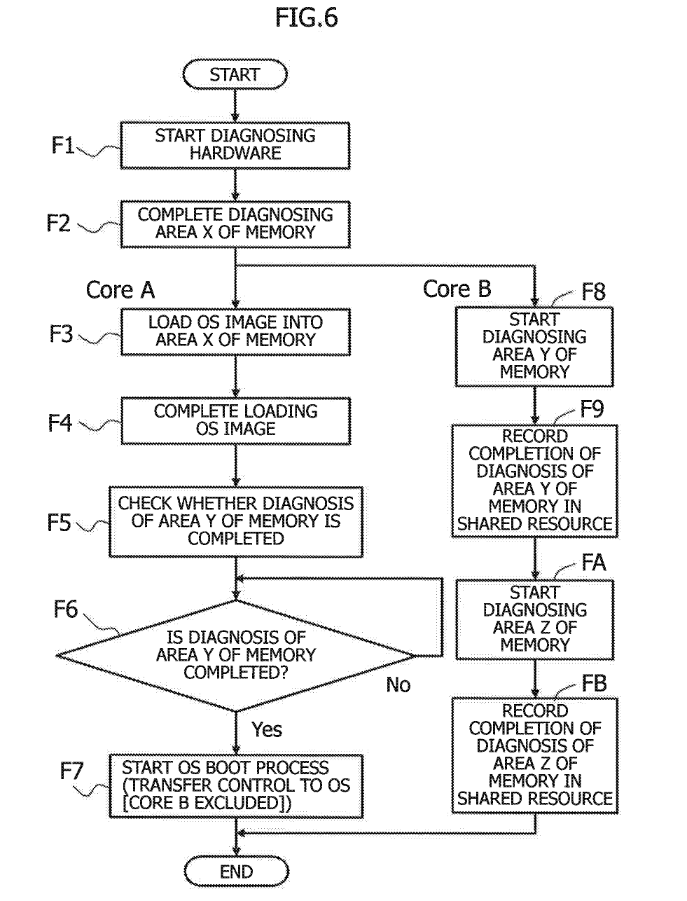

FIG. 5 illustrates processes when booting the present information processing apparatus. The information processing apparatus starts the processes in FIG. 5 upon the power-on or resetting and other equivalent trigger. To begin with, the CPU 1 (the core A or the core B) of the information processing apparatus executes initializing and diagnosing the area X of the memory 3 (S1). In FIG. 5, however, the initialization/diagnosis is simply termed “diagnosis”. Note that the initialization/diagnosis is simply termed “diagnosis” also in the drawings from FIG. 6 onward according to the embodiment. Herein, the initialization/diagnosis is one example of an “initial process”. The process in S1 is one example of “executing an initial process containing at least one of an initialization process and a diagnosis process for a first area, used for loading Operating System from the input/output unit, of the main memory”.

When the CPU 1 (the core A or the core B) completes initializing the area X of the memory 3, e.g., the core B executes initializing and diagnosing the area Y of the memory 3 (S3). The process in S3 is one example of “starting the initial process for a remaining area, not yet subjected to the initial process, of the main memory during the processing by the first arithmetic processing unit”. The core B executing the process in S3 is one example of “a second arithmetic processing unit”. Hereat, e.g., the core A loads the OS image (S8). The process of loading the OS image in S8 is one example of “loading”. The core A executing the process in S8 is one example of “a first arithmetic processing unit”.

When the core B completes initializing and diagnosing the area Y of the memory 3 (Yes in S4), e.g., the core B further executes initializing and diagnosing the area Z of the memory (S5). A case of “Yes” in S4 is one example of “completing the initial process for a second area enabling the boot of at least part of the Operating System”. Hereat, e.g., the core A starts an OS boot process (S9). The process in S9 is one example of “the first arithmetic processing unit, upon completion of loading, starts booting the Operating System”. When the core B further completes initializing and diagnosing the area Z, the CPU 1 (the core A or the core B) executes the OS boot process pertaining to the area Z of the memory (S7).

### Embodiment 1

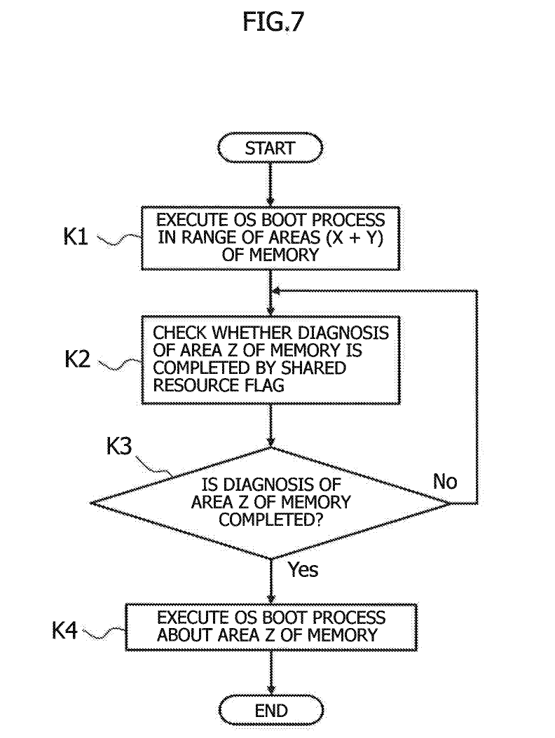

Processes of the information processing apparatus according to Embodiment 1 will hereinafter be described with reference to FIGS. 6 and 7. Embodiment 1 further concretizes the processes of the information processing apparatus illustrated in FIGS. 1 through 5. The configuration of the information processing apparatus is therefore the same as the configuration depicted in FIGS. 1 and 2. FIG. 6 is a flowchart illustrating processes of the firmware of the information processing apparatus. The CPU 1 (e.g., the core A) starts of the processes in FIG. 6 as being triggered by the power-on or the resetting of the information processing apparatus. Note that any one or both of the core A and the core B may execute the firmware after the power-on or the resetting.

The CPU 1, to begin with, starts diagnosing the hardware of the information processing apparatus (F1). The diagnosis of the hardware includes setting peripheral devices instanced by the I/O controller 4 and other equivalent devices other than the memory 3 and the initialization/diagnosis of the memory 3. The process in F1 is one example of “executing an initial process containing at least one of initialization process and a diagnosis process for a first area, used for loading Operating System from the input/output unit, of the main memory”. When the CPU 1 completes initializing and diagnosing the area X of the memory 3 (F2), e.g., the core A starts loading the OS image into the area X of the memory 3 (F3). The process in F3 is one example in which “a first arithmetic processing unit of the plurality of arithmetic processing units, upon completing the initial process for the first area, loads the Operating System from the input/output unit”.

The core A, upon completion of loading the OS image (F4), checks whether the core B completes diagnosing the area Y of the memory 3 (F5). The core B notifies the core A that the core B completes diagnosing the area Y of the memory 3 via the interface on the core-to-core shared resource instanced by the SRAM 5 and other equivalent resources illustrated in FIG. 1 or via the core-to-core asynchronous interruption unit and other equivalent units. When not yet completing the diagnosis of the area Y of the memory 3, the core A loops back control to F5. Whereas when completing the diagnosis of the area Y of the memory 3, the core A starts the OS boot process. To be specific, the core A transfers the control to the OS loaded into the area X (F7). The process in F7 is one example in which “the first arithmetic processing unit (core A), upon completion of loading, starts booting the Operating System”.

On the other hand, when the CPU 1 completes initializing and diagnosing the area X of the memory 3 (F2), e.g., the core B starts diagnosing the area Y of the memory 3 (F8). The core B, upon the completion of diagnosing the area Y of the memory 3, records its completion in the interface on the core-to-core shared resource (F9).

Next, the core B starts initializing and diagnosing the remaining area Z of the memory 3 (FA). The core, upon the completion of initializing and diagnosing the area Z of the memory 3, records its completion in the interface on the core-to-core shared resource (FB). Note that the core B may notify the core A of the completion via the core-to-core asynchronous interruption unit and other equivalent units.

FIG. 7 is a flowchart illustrating details of the OS boot process (F7 in FIG. 6). In this process, the core A executes the OS boot process in a range of, e.g., “area X+area Y” of the memory 3 (K1). Herein, the OS boot process in the range of “area X+area Y” is exemplified by a process of setting the page table in the range of “area X+area Y” of the memory 3, a process of setting management information of OS Processes in the range of “area X+area Y” of the memory 3, and other equivalent processes.

Next, the core A determines whether the diagnosis of the area Z of the memory 3 is completed (K3). A determination method in K3 is the same as the method in F5 of FIG. 6. When not completing the diagnosis of the area Z, the core A loops back the control to K2. Whereas when completing the diagnosis of the area Z, the core A executes the OS boot process for the area Z of the memory 3 (K4). The OS boot process for the area Z is exemplified by setting the page table for the area Z, and other equivalent processes.

As described above, in Embodiment 1, the CPU 1 (e.g., the core A), when completing the diagnosis of the area X for loading the OS image, loads the OS image into the area X. The core A loads the OS image into the area X, during which the core B executes initializing and diagnosing the areas Y and Z. The information processing apparatus according to Embodiment 1 is therefore enabled to execute in parallel the process of loading the OS image into the area X at an earlier stage than hitherto and the process of initializing and diagnosing the areas Y and Z simply by initializing and diagnosing the area X for loading the OS image. The core A and the core B can transfer and receive the completion range of the initialization process of the main memory by using the shared resources instanced by the asynchronous interruption unit or the SRAM 5 and other equivalent resources.

According to Embodiment 1, when the core B completes initializing and diagnosing the area Y, the core A can starts the OS boot process in parallel with the process of the core B. Accordingly, the information processing apparatus according to Embodiment 1 can boot the OS by the parallel processes of the core A and the core B. As described above, according to Embodiment 1, the information processing apparatus can starts the parallel processes of the core A and the core B at the earlier stage than hitherto.

The information processing apparatus can improve the access efficiency to the memory 3 by executing in parallel the process of loading the OS image into the area X and the process of initializing and diagnosing the areas Y and Z. In other words, it happens as the case may be that the boot time elongates on the whole due to being unable to efficiently use the memory band to the memory 3 as derived from the access speed to the I/O 6 in the process of loading the OS image into the area X. The processes in Embodiment 1 enable the boot time to be reduced on the whole because of being able to use the access band to the memory 3 more efficiently than hitherto when loading the OS image by initializing and diagnosing the areas Y and Z.

The information processing apparatus can improve the access efficiency to the memory 3 by executing in parallel the OS boot process and the process of initializing and diagnosing the area Z. In other words, the OS boot process involves a case in which the access band to the memory 3 is not sufficiently used when accessing the memory 3 due to the access speed to the I/O 6. However, the processes according to Embodiment 1 enable the boot time to be reduced on the whole because of being able to use the access band to the memory 3 more efficiently than hitherto when booting the OS by initializing and diagnosing the area Z.

### Embodiment 2

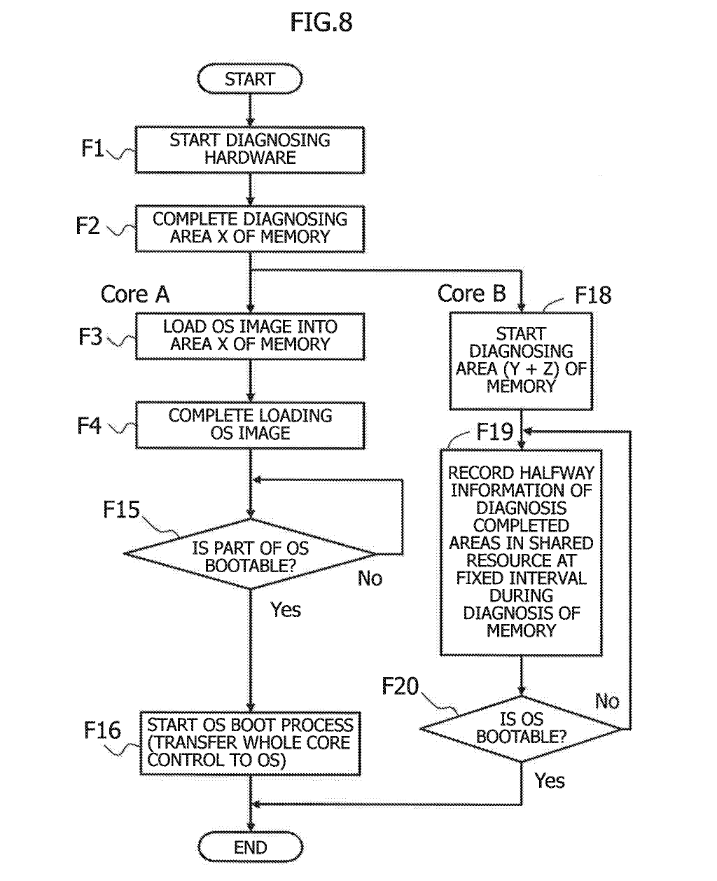

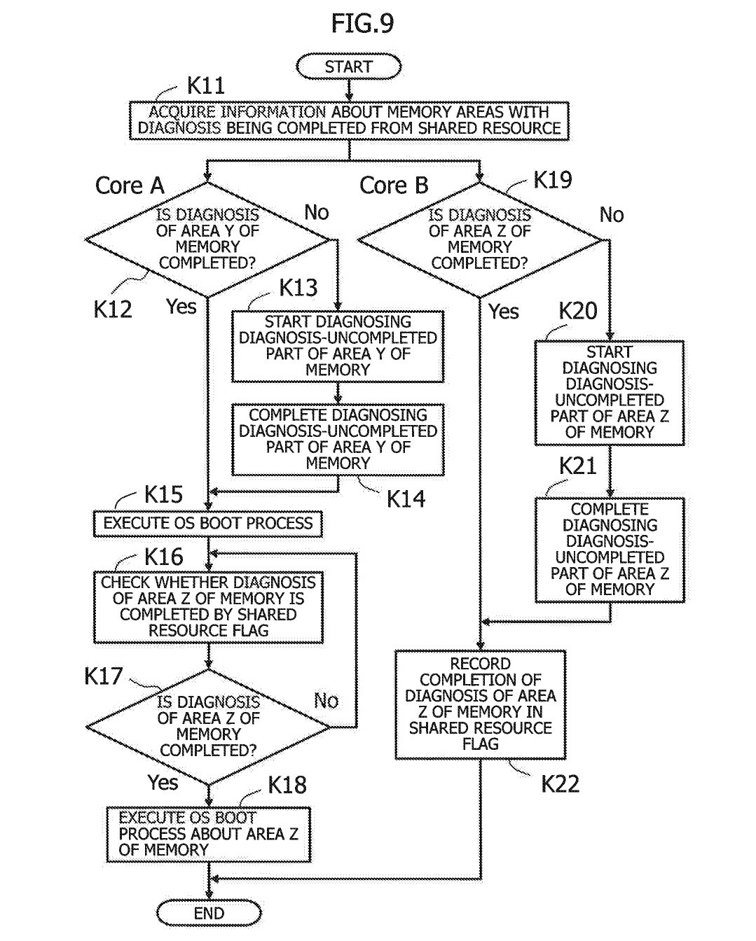

Processes of the present information processing apparatus according to Embodiment 2 will be described with reference to FIGS. 8 and 9. In Embodiment 2 also, the configuration of the information processing apparatus is the same as the configuration illustrated in FIGS. 1 and 2. In Embodiment 1, the core B, upon completion of initializing and diagnosing the area Y, continues initializing and diagnosing the remaining area Z. By contrast, in Embodiment 2, the core B momentarily notifies the core A of items of information about the areas with the initialization/diagnosis being completed, e.g., at a predetermined interval via the shared resource, while the core A boots the OS when reaching a partial bootable status of the OS. When the memory 3 has the areas with the initialization/diagnosis not yet being completed, the core A and the core B execute initializing and diagnosing the areas with the initialization/diagnosis not yet being completed. Other procedures in Embodiment 2 are the same as the processes in FIGS. 6 and 7. Such being the case, the same processes in Embodiment 2 as those in Embodiment 1 are marked with the same numerals and symbols as those in FIGS. 6 and 7, and hence their explanations are omitted.

FIG. 8 is a flowchart illustrating the processes of the firmware in Embodiment 2. In FIG. 8, as described above, the processes in F1 through F4 are the same as the processes in FIG. 6, and hence their explanations are omitted. The core A, upon the completion of loading the OS image, determines whether part of the OS is bootable (F15). The determination about whether part of the OS is bootable is made based on the information of the areas with the initialization/diagnosis being already completed, the information being notified from the core B via the shared resource. For example, when having completed the initialization/diagnosis of the area Y for booting the OS in the areas of the memory 3 described in FIGS. 2 through 4 and in Embodiment 1, the core A can determine that part of the OS is bootable. The core A may, however, determine that part of the OS is bootable also when completing the initialization/diagnosis of the area narrower than the area Y for booting the OS. For instance, the core A can determine that part of the OS is bootable when completing the initialization/diagnosis of the area with at least one Process being executable when booting the OS. Accordingly, though omitted in FIG. 8, along with the core B momentarily progressing the initialization/diagnosis of the areas of the memory 3, the core A may momentarily expand a range enabling the determination that part of the OS is bootable. The core A, when determining that part of the OS is bootable, starts the OS boot process (F16). The processes in F15-F16 are one example of “booting the Operating System upon completing the initial process fora second area enabling the boot of at least part of the Operating System”. The core A executing the processes in F15-F16 is one example of “a first arithmetic processing unit”.

On the other hand, in parallel with the process (F3) in which the core A loads the OS image into the area X of the memory 3, the core B starts initializing and diagnosing the areas Y and Z of the memory 3 (F18). The core B records, in the shared resource, halfway information of the areas with the diagnosis being already completed at a predetermined time interval or per completion with predetermined memory area granularity when making the initialization/diagnosis of the memory 3 (F19). The predetermined time interval, timing of every completion with the predetermined memory area granularity, and other equivalent intervals will hereinafter be generically termed the predetermined interval.

FIG. 9 is a flowchart illustrating details of the OS boot process (F16 in FIG. 8). In this process, e.g., the core A of the CPU 1 acquires information about the areas, with the diagnosis being completed, of the memory 3 from the shared resource (K11). For instance, the core A determines whether the initialization/diagnosis the area Y of the memory 3 is completed or not (K12). When the initialization/diagnosis the area Y is not completed, the core A starts initializing and diagnosing the diagnosis uncompleted part of the area Y (K13). Then, the core A completes initializing and diagnosing the diagnosis uncompleted part of the area Y (K14).

Next, the core A executes the OS boot process (K15). Upon completion of the OS boot process, the core A checks the completion of the diagnosis of the area Z by using a shared resource flag (K16). When the diagnosis of the area Z of the memory 3 is not completed, the core A loops back the control to K16. Whereas when the diagnosis of the area Z of the memory 3 is completed, the core A executes the OS boot process about the area Z of the memory 3 (K18). The processes in K12 through K15 are one example of “booting part of the Operating System, executing an initial process for a partial area, not yet subjected to the initial process, of the second area, and booting the Operating System”.

On the other hand, the core B determines whether the initialization/diagnosis of the remaining area Z of the memory 3 is completed (K19) in parallel with the processes ranging from the process (K12) in which the core A determines whether the diagnosis of the area Y of the memory 3 is completed to the OS boot process (K15). When the initialization/diagnosis of the area Z is not completed, the core B starts initializing and diagnosing the diagnosis uncompleted part of the area Z (K20). Then, the core B completes initializing and diagnosing the diagnosis uncompleted part of the area Z (K21). Next, the core B records the completion of the diagnosis of the area Z of the memory 3 in the shared resource flag (K22). The processes in K12 through K14 and the processes in K19 through K21 are one example of “when the initial process for the remaining area is not finished, executing the initial process for the remaining area in parallel”. The processes in K19 through K21 are one example of “executing the initial process for the remaining area when the initial process for the remaining area of the main memory is not finished upon booting the Operating System”. In these processes in FIGS. 8 and 9, e.g., the core A or the core B, when not completing the initialization/diagnosis of the remaining area (Y or Z) in the processes of F1, F18, executes initializing and diagnosing the remaining area in parallel with the process by the co-processor core (K13, K14, K20, K21). Accordingly, the plurality of cores executes the boot process in parallel while efficiently using the memory band, whereby the OS can be booted early.

As discussed above, according to Embodiment 2, the core B records the halfway information of the diagnosis completed areas at the predetermined interval in the shared resource while executes initialization/diagnosis of the areas Y and Z by running the firmware. When reaching the OS bootable status, the core B finishes the firmware process, and transfers to the OS-based control. Accordingly, the core A to boot the OS can boot at least part of the OS before completing the initialization/diagnosis of the area Y, i.e., at the earlier stage than in Embodiment 1. In this status, the core A and the core B determine, based on the process of the OS during the boot of the OS, whether the initialization/diagnosis of the remaining area of the memory 3 is completed.

For example, in FIG. 9, the core A, when determining that the initialization/diagnosis of the area Y is not completed after transferring to the control to the OS, executes the OS boot process by initializing and diagnosing the area Y. The core B, when the diagnosis of the area Z is not completed after transferring the control to the OS, performs initializing and diagnosing the area Z. Accordingly, the processes in Embodiment 2 enable the CPU 1 (the core A and the core B) to boot at least part of the OS at the earlier stage than in Embodiment 1 and to initialize and diagnose the initialization/diagnosis uncompleted areas during the boot of the OS or after booting the OS.

According to Embodiment 2, the core A and the core B, when not completing the initialization/diagnosis of the remaining areas (Y, Z), can execute initializing and diagnosing the remaining areas mutually in parallel with the processing of the co-processor core. For example, the processes in K13, K14, K15 are executed by the core A in parallel with the processes in K20, K21 executed by the core B.

### Embodiment 3

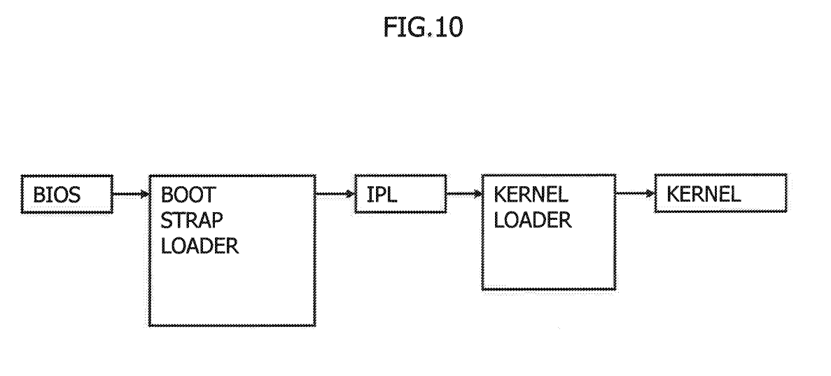

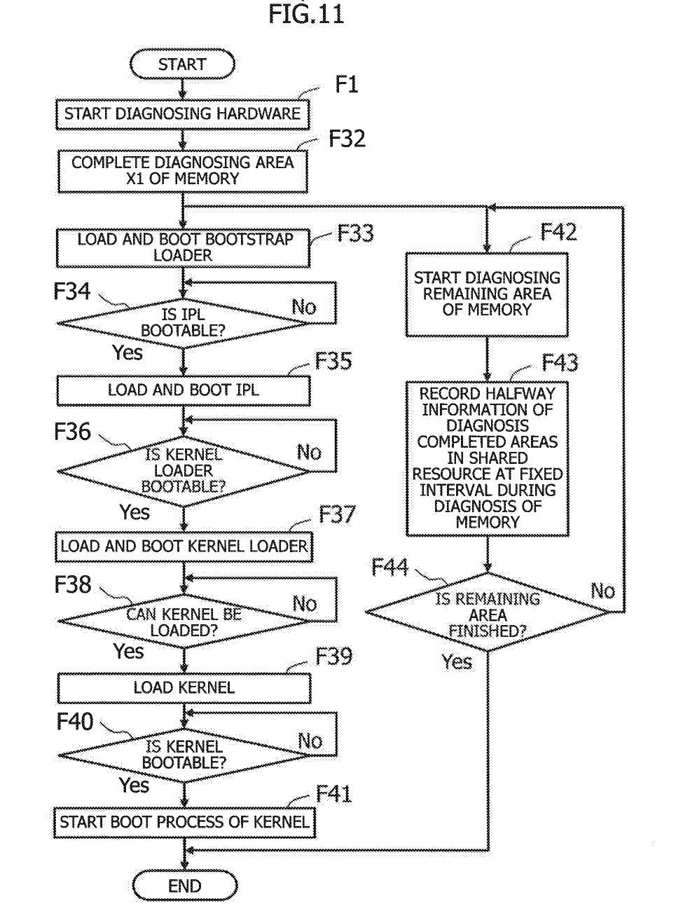

Processes of the information processing apparatus according to Embodiment 3 will be described with reference to FIGS. 10 and 11. Embodiment 3 will describe the processes when booting the OS installed in a personal computer, a server and other equivalent apparatuses. FIG. 10 is a diagram illustrating a boot procedure when booting the information processing apparatus according to Embodiment 3. In Embodiment 3, upon the power-on or resetting, the CPU 1 (e.g., the core B) boots the firmware (e.g., BIOS) stored in the ROM 8. The core B runs the firmware to execute a variety of check processes and acquire various items of information by accessing the memory controller 2, the I/O controller 4 and other equivalent controllers each connected to the CPU 1 itself via the internal bus 7. The core A executes a POST process by the firmware, and performs detecting, initializing and setting the memory and the peripheral devices.

According to Embodiment 3, at first, the initialization/diagnosis of an area X1, as part of the memory 3, for booting a bootstrap loader is completed in the initialization/diagnosis of the memory 3. Then, the core B to run the firmware loads the bootstrap loader from the core A via the flag on the shared resource or the unit instanced by the core-to-core asynchronous interruption unit, and boots the loader. Note that the core B continues initializing and diagnosing the memory throughout as it is, and recording the halfway information of the completed areas with the initialization/diagnosis being completed at every predetermined interval in the shared resource.

The core A, when determining that the initialization/diagnosis of an area X2 is completed, loads IPL (Initial Program Loader) in a boot sector of a hard disk, and jumps to an entry point of the IPL on the area X2. The core A, upon booting the IPL, determines from the record on the shared resource whether the initialization/diagnosis of an area X3 for booting a kernel loader is completed.

The core A, when determining that the initialization/diagnosis of the area X3 is completed, loads the kernel loader in a predetermined area (e.g., in a route directory) on the hard disk into the area X3, and jumps to the entry point of the kernel loader on the area X3. Furthermore, the core A, upon booting the kernel loader, determines from the record on the shared resource whether the initialization/diagnosis of an area X4 for loading a kernel image is completed.

The core A, when determining that the initialization/diagnosis of the area X4 is completed, loads the kernel image in the predetermined area (e.g., the route directory) on the hard disk into the area X4, and jumps to the entry point of the kernel image on the area X4. The core A, when loading the kernel image and jumping to the entry point, determines from the record on the shared resource whether the initialization/diagnosis of an area X5 for booting the kernel is completed.

The core A, when determining that the initialization/diagnosis of the area X5 is completed, starts booting the kernel. In other words, the core A sets the page table about the area X5. Further, the core A boots a variety of OS Processes instanced by managing the storage, devices and other equivalent components.

FIG. 11 is a flowchart illustrating the processes of the information processing apparatus according to Embodiment 3. A start of these processes is triggered by an operation instanced by the power-on or resetting. For example, the core B of the CPU 1 starts diagnosing the hardware (F1). The core B completes diagnosing the area X1 of the memory 3 (F32). The area X1 is an area, having a capacity enabling, e.g., the bootstrap loader to be booted, of the memory 3.

The core B instructs the core A to boot the bootstrap loader, e.g., by the core-to-core asynchronous interruption. The core A loads the bootstrap loader into the area X1, and jumps to the entry point of the bootstrap loader on the area X1. In this process, the core A boots the bootstrap loader (F33).

Next, the core A determines based on the notification, recorded on the shared resource, from the core B whether the initialization/diagnosis of the area X2, for booting the IPL, of the memory 3 is completed (F34). When the IPL is bootable, the core A loads the IPL into the area X2, and jumps to the entry point of the IPL, thereby booting the IPL (F35).

Subsequently, the core A determines based on the notification, recorded on the shared resource, from the core B whether the initialization/diagnosis of the area X3, for booting the kernel loader, of the memory 3 is completed (F36). When the kernel loader is bootable, the core A loads the kernel loader into the area X3, and jumps to the entry point of the kernel loader, thereby booting the kernel loader (F37).

Next, the core A determines based on the notification, recorded on the shared resource, from the core B whether the initialization/diagnosis of an area X4, for booting the kernel image, of the memory 3 is completed (F38). When the kernel image is bootable, the core A loads the kernel image into the area X4 (F39).

Subsequently, the core A determines based on the notification, recorded on the shared resource, from the core B whether the initialization/diagnosis of the area X5, for booting the kernel, of the memory 3 is completed (F40). When the kernel is bootable, the core A jumps to the entry point of the kernel, thereby booting the kernel (F41).

In parallel with the processes, by the core A, from booting the bootstrap loader (F33) to executing the kernel boot process (F41), the core B starts diagnosing the remaining area of the memory 3 (F42). The core B records the halfway information about the completion of the diagnosis of the remaining area of the memory 3 in the shared resource at the predetermined interval (F43). The core B determines whether the initialization/diagnosis of the remaining area is finished. When the initialization/diagnosis of the remaining area is not finished, the core B loops back the control to F42. Whereas when the initialization/diagnosis of the remaining area is finished, the core B finishes processing.

As described above, the CPU 1, e.g., the core B of the information processing apparatus according to Embodiment 3 records the halfway information about the completion of the diagnosis in the shared resource at the predetermined interval along with the initialization/diagnosis of the areas of the memory 3. On the other hand, the core A determines from the halfway information, recorded in the shared resource, about the completion of the diagnosis whether the bootstrap loader, the IPL, the kernel loader and other equivalent programs are bootable, and boots the bootstrap loader, the IPL, the kernel loader and other equivalent programs in parallel with the initialization/diagnosis of the memory 3. The core A further determines whether the kernel image can be loaded and whether the kernel is bootable, and executes loading the kernel image and booting the kernel. Therefore, the information processing apparatus according to Embodiment 3 can determine by far more minutely than Embodiment 1 and Embodiment 2 whether the firmware and the multi-stage boot program are bootable, and can start the process of booting the firmware and the multi-stage boot program at the early stage in parallel with the initialization/diagnosis of the memory 3.

Note that the core B executes initializing and diagnosing the hardware and also the area X1 of the memory 3, and notifies the co-processor core of the completion of the initialization/diagnosis in Embodiment 3. The core A may, however, execute these processes, and the core A and the core B may also cooperate to execute the processes.

### Embodiment 4

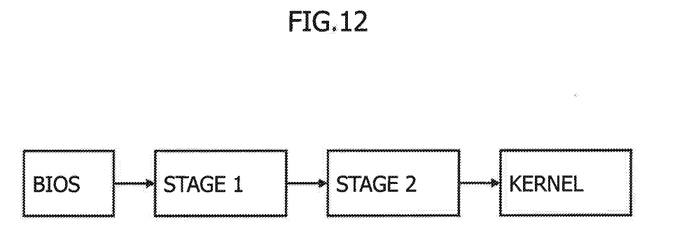

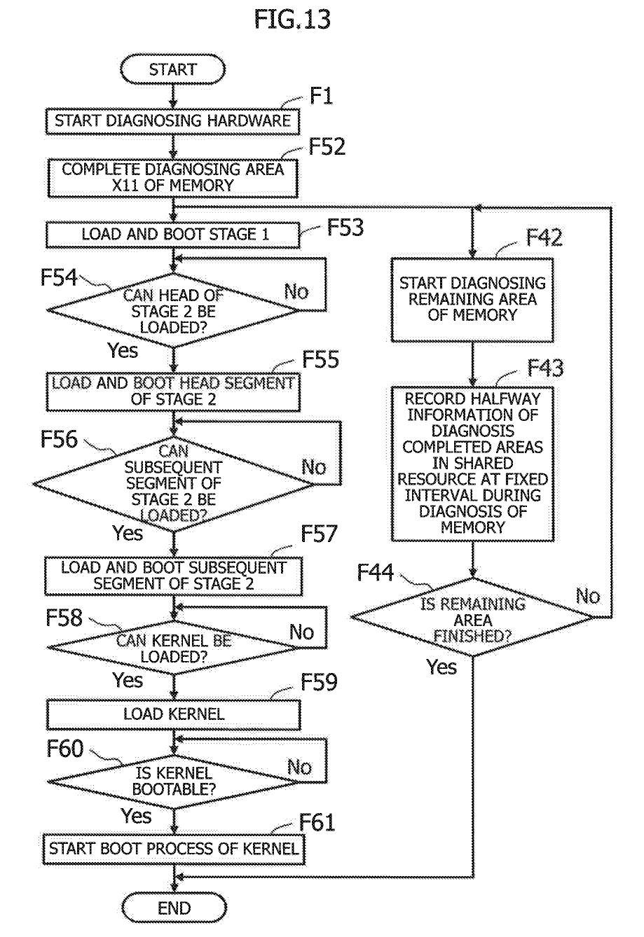

Processes of the information processing apparatus according to Embodiment 4 will be described with reference to FIGS. 12 and 13. Embodiment 4 will describe the processes when booting another OS installed in the personal computer, the server and other equivalent apparatuses. FIG. 12 is a diagram illustrating a boot procedure when booting the information processing apparatus according to Embodiment 4. In the information processing apparatus according to Embodiment 4 also, upon the operation instanced by the power-on or resetting, the CPU 1 (e.g., the core B) boots the firmware (e.g., BIOS) stored in the ROM 8. These processes are the same as those in Embodiment 3.

In Embodiment 4, the boot program is separated into two stages, e.g., STAGE 1 and STAGE 2. In Embodiment 4, it does not, however, mean that a number of stages of the boot program is limited to “2”. Similarly to Embodiment 3, the CPU 1, e.g., the core B of the information processing apparatus according to Embodiment 4 records the halfway information of the completion of the diagnosis in the shared resource at the predetermined interval along with the initialization/diagnosis of the areas of the memory 3. On the other hand, the core A determines from the halfway information, recorded in the shared resource, of the completion of the diagnosis whether STAGE 1 and STAGE 2 are bootable, and sequentially boots STAGE 1 and STAGE 2. The core A further determines whether the kernel image can be loaded and whether the kernel is bootable, and executes loading the kernel image and booting the kernel.

FIG. 13 is flowchart illustrating processes of the information processing apparatus according to Embodiment 4. Upon the operation instanced by the power-on or resetting, the core B of the CPU 1 starts diagnosing the hardware (F1). Then, the core B completes diagnosing an area X11 of the memory 3 (F52). The area X11 is an area, having a capacity enabling STAGE 1 to be booted, of the memory 3.

The core B instructs the core A to boot STAGE 1, e.g., by the core-to-core asynchronous interruption. Thereupon, the core A loads STAGE 1 into the area X11, and jumps to the entry point of STAGE 1 on the area X11. Through this process, the core A boots STAGE 1 (F53).

Next, the core A determines based on the notification recorded in the shared resource and given from the core B whether the initialization/diagnosis of an area X12, for booting a head segment of STAGE 2, of the memory 3 is completed (F54). When the head segment of STAGE 2 is bootable, the core A loads the head segment into the area X12 and jumps to the entry point thereof, thereby booting the head segment of STAGE 2 (F55).

Next, the core A determines based on the notification recorded in the shared resource and given from the core B whether the initialization/diagnosis of an area X13, for booting a subsequent segment of STAGE 2, of the memory 3 is completed (F56). When the subsequent segment of STAGE 2 is bootable, the core A loads the subsequent segment of STAGE 2 into the area X13 and jumps to the entry point thereof, thereby booting the subsequent segment of STAGE 2 (F57). Note that the subsequent segment of STAGE 2 is booted through the determination and the process in F56 and F57 of FIG. 13. The subsequent segment may, however, be separated into a plurality of segments and loaded and booted a plural number of times separately. When the subsequent segment is separated into the plurality of segments, it follows that the processes corresponding to F56 and F57 are repeated a plural number of times.

Subsequently, the core A executes the following processes by STAGE 2. To be specific, the core A determines based on the notification recorded in the shared resource and given from the core B whether the initialization/diagnosis of an area X14, for loading the kernel image, of the memory 3 is completed (F58). When the kernel image can be loaded, the core A loads the kernel image into the area X14 (F59). Note that the kernel image is compressed in, e.g., the self-extracting type and thus loaded in Embodiment 4. In the next boot process, the kernel itself deploys the kernel image on the memory 3 while performing its self-extraction.

Specifically, the core A determines based on the notification recorded in the shared resource and given from the core B whether the initialization/diagnosis of the area Y, for booting the kernel, of the memory 3 is completed (F60). When the kernel is bootable, the core A jumps to the entry point of the kernel, thereby booting the kernel (F61). The core A deploys the kernel image on the memory 3, while the kernel performs its self-extraction.

In parallel with the processes, by the core A, from loading and booting the STAGE 1 (F53) to executing the kernel boot process (F61), the core B starts diagnosing the remaining areas of the memory 3 (F42-F44). The processes in F42 through F44 are the same as those in FIG. 11, and hence their explanations are omitted.

As described above, the CPU 1, e.g., the core B of the information processing apparatus according to Embodiment 4 records the halfway information of the completion of the diagnosis in the shared resource at the predetermined interval along with the initialization/diagnosis of the areas of the memory 3. On the other hand, the core A determines from the halfway information, recorded in the shared resource, of the completion of the diagnosis whether STAGE 1 and STAGE 2 are bootable, and loads and boots STAGE 1 and STAGE 2 in parallel with the initialization/diagnosis of the memory 3. The core A further determines whether the kernel image can be loaded and whether the kernel is bootable, and executes loading the kernel image and booting the kernel.

Note that the core B executes initializing and diagnosing the hardware and also the memory 3, and notifies the co-processor core of the completion of the initialization/diagnosis also in Embodiment 4 similarly to Embodiment 3. The core A may, however, execute these processes, and the core A and the core B may also cooperate to execute the processes.

As described above, similarly to Embodiment 3, the information processing apparatus according to Embodiment 4 gives the instruction of the firmware process and determines whether the multi-stage boot program is bootable by far more minutely than in Embodiment 1 and Embodiment 2. It is thereby feasible to execute the initialization/diagnosis process of the memory 3 and the process of booting the multi-stage boot program further minutely in parallel, whereby the boot program can be started at the early stage, and the boot time of the system as a whole can be reduced.

The present information processing apparatus enables the usage efficiency of the computer to be improved by reducing the boot time of the computer system to the greater degree than hitherto.

<Non-Transitory Computer Readable Recording Medium>

A program, firmware and other equivalent software components for making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM (Compact Disc-Read Only Memory), a CD-R/W, a DVD (Digital Versatile Disk), a Blu-ray disc, a DAT (Digital Audio Tape), an 8 mm tape, and a memory card like a flash memory. A hard disc, a ROM and other equivalent recording mediums are given as the non-transitory recording mediums fixed within the computer and other equivalent apparatuses. Still further, a solid state drive (SSD) is also available as the non-transitory recording medium removable from the computer and other equivalent apparatuses and also as the non-transitory recording medium fixed within the computer and other equivalent apparatuses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a plurality of arithmetic processing units;
a main memory to be accessible respectively from the plurality of arithmetic processing units; and
an input/output unit to be accessible respectively from the plurality of arithmetic processing units,
wherein at least any one of the plurality of arithmetic processing units executes an initial process containing at least one of an initialization process and a diagnosis process for a first area, used for loading Operating System from the input/output unit, of the main memory,
a first arithmetic processing unit of the plurality of arithmetic processing units, upon completing the initial process for the first area, loads the Operating System into the first area from the input/output unit,
a second arithmetic processing unit of the plurality of arithmetic processing units starts the initial process for a remaining area, not yet subjected to the initial process, of the main memory during the processing by the first arithmetic processing unit, and
the first arithmetic processing unit, upon completion of loading, starts booting the Operating System.

2. The information processing apparatus according to claim 1, wherein the plurality of arithmetic processing units, when the initial process for the remaining area is not finished, executes the initial process for the remaining area in parallel.

3. The information processing apparatus according to claim 1, further comprising an interface unit to notify the plurality of arithmetic processing units of a completion range of the process of initializing the main memory.

4. The information processing apparatus according to claim 1, wherein the first arithmetic processing unit boots the Operating System upon completing the initial process for a second area enabling the boot of at least part of the Operating System, and
the second arithmetic processing unit finishes the initial process upon completing the initial process for the second area, and executes the initial process for the remaining area when the initial process for the remaining area of the main memory is not finished upon booting the Operating System.

5. The information processing apparatus according to claim 4, wherein the first arithmetic processing unit boots part of the Operating System, executes the initial process for a partial area, not yet subjected to the initial process, of the second area, and boots the Operating System.

6. A computer-readable recording medium having stored therein a program for causing a computer including a plurality of arithmetic processing units to execute a process comprising:
causing at least any one of the plurality of arithmetic processing units to execute an initial process containing at least one of an initialization process and a diagnosis process for a first area, used for loading Operating System from the input/output unit, of the main memory;
causing a first arithmetic processing unit of the plurality of arithmetic processing units to, upon completing the initial process for the first area, load the Operating System into the first area from the input/output unit;
causing a second arithmetic processing unit of the plurality of arithmetic processing units to start the initial process for a remaining area, not yet subjected to the initial process, of the main memory during the processing by the first arithmetic processing unit; and
causing the first arithmetic processing unit to, upon completion of loading, start booting the Operating System.

7. The computer-readable recording medium according to claim 6, further causing the plurality of arithmetic processing units to execute, when the initial process for the remaining area is not finished, the initial process for the remaining area in parallel.

8. The computer-readable recording medium according to claim 6, further causing the plurality of arithmetic processing units to notify of a completion range of the process of initializing the main memory via an interface unit between the plurality of arithmetic processing units.

9. The computer-readable recording medium according to claim 6, further causing the first arithmetic processing unit to boot the Operating System upon completing the initial process for a second area enabling the boot of at least part of the Operating System, and
causing the second arithmetic processing unit to finish the initial process upon completing the initial process for the second area, and to execute the initial process for the remaining area when the initial process for the remaining area of the main memory is not finished upon booting the Operating System.

10. The computer-readable recording medium according to claim 9, further causing the first arithmetic processing unit to boot part of the Operating System, to execute the initial process for a partial area, not yet subjected to the initial process, of the second area, and to boot the Operating System.
